(19) United States
(12) Patent Application Publication
(10) Pub. No.: US 2006/0032956 A1
(43) Pub. Date: Feb. 16, 2006

(54) Dual receptable lift mobile paper shredder

(76) Inventor: Robert C. Rajewski, Stettler (CA)

Correspondence Address: THOMPSON LAMBERT;SUITE 703D, CRYSTAL PARK TWO, 2121 CRYSTAL DRIVE, ARLINGTON, VA, 22202, US

(21) Appl. No.: 10/915,386

(22) Filed: Aug. 11, 2004

(51) Int. Cl. B02C 19/00

(52) U.S. Cl. 241/101.74

(57) ABSTRACT

A mobile paper shredder has a first feed compartment, a first receptacle lift associated with the first feed compartment for conveying paper to the first feed compartment, paper shredding implements disposed to receive paper from the first feed compartment and discharge shredded paper, a conveyor disposed to receive shredded paper discharged by the paper shredding implements and to convey shredded materials to a storage container disposed to receive shredded paper from the conveyor, a second feed compartment on the storage container, and a second receptacle lift associated with the second feed compartment for conveying paper into the second feed compartment, the storage container disposed to receive paper from the second feed compartment to store the paper for hauling away. The mobile paper shredder permits the operator to load both paper for shredding and paper that does not require shredding simultaneously, thus saving time and energy previously required to shred all materials, including materials that did not require shredding.

### BACKGROUND OF THE INVENTION

This invention relates to an improved mobile paper shredder having a dual capacity as a shredder and a transfer truck.

Truck-mounted paper shredding assemblies (“shredders”) are commonly in use today. These units move about from one office to another to shred often confidential paper documents.

For a long time, mobile paper shredders used knives or cam type cutting devices to shred the paper into strips. In general, these shredders rely on manual feeding of paper to ensure that the paper enters the machine at an even thickness and rate. As a consequence, they are relatively slow in processing paper.

U.S. Pat. No. 5,542,617, issued to D. E. Rajewski, discloses the use of a rotary hammer mill to shred the paper. Canadian patent No. 2,225,900 issued, Sep. 26, 2000, discloses a further truck-mounted paper shredder. The shredder uses a reciprocating plunger to feed a rotary hammer mill, which shreds the paper. An auger is used to transfer the shredded paper into a discrete storage container. The container includes a suction device to pull dust through the assembly into a filter in the container. The container is separate so that it can be removed when loaded and left standing for later pick up, allowing the truck and shredder to take on an empty container and move on to the next job.

While these hammer-type paper shredders appear to have performed their intended functions, paper dust caused by the hammer action caused an explosion hazard and the feed mechanisms were awkward to use. Canadian patent application 2,432,199, filed Jun. 13, 2003 by the inventor of the present application, sought to remedy some of these problems. It discloses an improved feed mechanism, as well as a sprayer to keep down dust caused by the paper shredding implements.

While the sprayer works well to reduce the risk of an explosion hazard, further improvements to a paper shredder, particularly an improved mobile paper shredder using hammers are disclosed in U.S. patent application Ser. No. 10/771,122 filed Feb. 4, 2004 by the present inventor. It discloses an auger with wear plates on the flights that may be made of spark resistant material and may be replaced.

The same application also describes an improved transfer truck for times when either the location of the materials for shredding or the quantity of materials for shredding make it inconvenient to shred the materials on site. For example, if the location is far from a recycling facility or otherwise particularly remote, the added time and expense involved in shredding the materials on-site and then hauling them to another location for recycling, or alternatively, in leaving the container on-site for later retrieval, might make it uneconomical or not feasible to shred materials on-site if there is a lack of extra containers to be left behind. Also, some sites may have such a great quantity of materials for shredding that multiple containers would be required, and in consequence, multiple trips to retrieve those containers would also be required.

While the transfer truck described allows for sorting materials at the time of collection rather than requiring sorting at a shredding and/or recycling facility, it has the drawback of not having the capability of the mobile shredder. At the same time, the mobile shredders known in the art assume that all materials picked up at a location require shredding, and therefore, everything goes through the shredder, even if this is not necessary.

### SUMMARY OF THE INVENTION

There is therefore provided in accordance with an aspect of the invention, a mobile paper shredder, comprising:

a first feed compartment;

a first receptacle lift associated with the first feed compartment for conveying paper to the first feed compartment;

paper shredding implements disposed to receive paper from the first feed compartment and discharge shredded paper;

a conveyor disposed to receive shredded paper discharged by the paper shredding implements and to convey shredded materials to a storage container disposed to receive paper from the conveyor;

a second feed compartment on the storage container;

and a second receptacle lift associated with the second feed compartment for conveying paper into the second feed compartment, the storage container disposed to receive paper from the second feed compartment to store the paper for hauling away.

These and other aspects of the invention may be found in the detailed description that follows and in the claims.

### BRIEF DESCRIPTION OF THE DRAWINGS

There will now be described a preferred embodiment of the invention, with reference to the drawings by way of illustration only, in which like reference characters denote like elements and in which:

FIG. 1 is a side elevation showing a shredder mounted on a truck, the shredder being shown in section;

FIG. 2 is a front end elevation of the shredder, showing internals in broken lines;

FIG. 3 a perspective view, with part of the housing and some parts removed, showing the internals of the feed compartment of the shredder;

FIG. 4 is a side view of a hopper divider according to the invention;

FIG. 5 is a side elevation, in section, showing the shredder and storage container linked in working relationship;

FIG. 6 is side view of the paper shredder of FIG. 6;

FIG. 7 is a perspective view of the auger assembly; and

FIG. 8 is a perspective view of the dual receptacle lifts on the paper shredding assembly.

### DESCRIPTION OF PREFERRED EMBODIMENTS

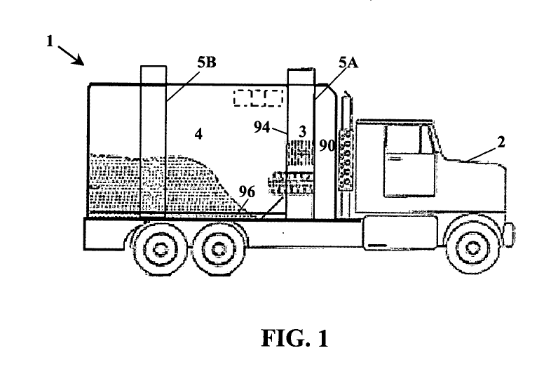

Having reference to FIG. 1, a paper-shredding assembly 1 is shown mounted on a truck 2. The assembly 1 comprises a shredder 3, a storage container 4, and receptacle lifts 5A and 5B.

More particularly, the shredder 3 comprises a housing 6 forming an upper feed compartment 7 and a lower chamber 8.

The feed compartment 7 is generally rectangular and has top, bottom and side walls 9, 10, 11 and first and second ends. At its first end, the top wall 9 forms a paper feed opening 13A having a hinged lid 14A. In one embodiment, the receptacle lift 5A may comprise lifting arms 15, pivotally attached to the housing 6, provided to lift a receptacle 16A and tip it to empty contained paper into the paper feed opening 13A. A hydraulic cylinder 17, pivotally attached to the housing 6 and arms 15, is provided to actuate the arms.

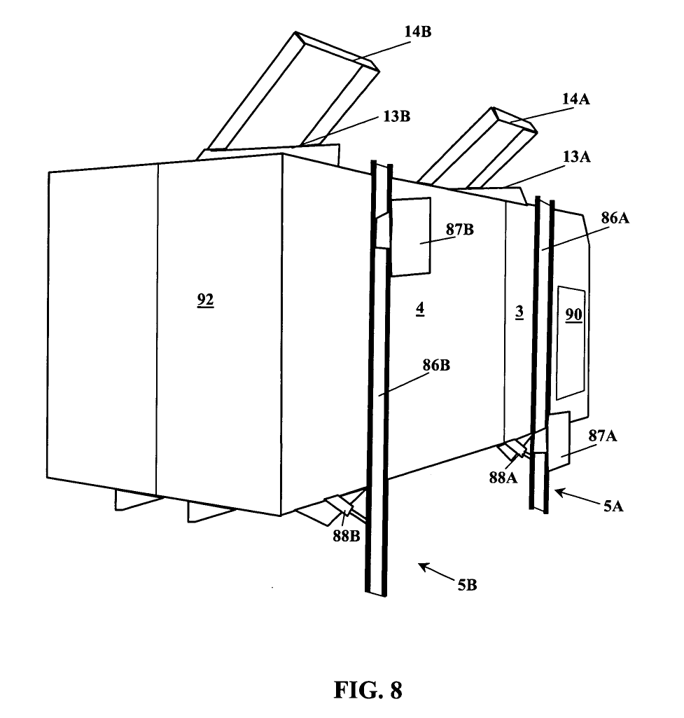

In a preferred embodiment, the receptacle lifts 5A and 5B, as shown in FIG. 8, comprise guides 86A and 86B which permit movement up and down for receptacle holders 87A and 87B to which attach receptacles (not shown) containing materials to be shredded or simply hauled away, as the case may be. The guides 86A and 86B are pivotally attached to hydraulic cylinders 88A and 88B, provided to force the guides 86A and 86B outward and cause the receptacles (not shown) to tilt and be emptied into the feed openings 13A and 13B.

Rubber belting 18 hangs partway down from the compartment top wall 9 and divides the compartment 7 into first and second sections 19, 20. The feed compartment bottom wall 10 forms a hammer mill opening 21 adjacent its second end. A sloped baffle 100 extends down from the first end side wall 11 and combines with the belting 18 to form a downwardly tapering feed passage 101.

A plunger 22 is located beneath the baffle 100 and on the bottom wall 10 at its first end. The plunger 22 extends transversely across the width of the feed compartment 7. A hydraulic cylinder 24 is connected at one end with the plunger 22 by a lug 25 extending through a slot (not shown) in the bottom wall 10. At its other end, the cylinder 24 is connected with a stationary lug 26 connected to the underside of the bottom wall 10. The cylinder 24 contracts to advance the plunger 22 along the bottom wall 10 toward the hammer mill opening 21 and expands to retract the plunger to the first end of the compartment 7. The cylinder 24 is actuated by the truck's hydraulic system (not shown). It is contemplated that an auger could be substituted for the plunger 22. However, the plunger 22 is preferred.

A hammer mill 30 is positioned in the lower chamber 8 immediately below the opening 21. The mill 30 comprises a shaft 31 carrying flails or hammers 32. It is contained within a semi-circular screen 33. The hammer mill is mounted to the side walls 11. It is driven by a pulley and belt system 34 connected with the power take-off (not shown) of the truck 2. The hammer mill 30 is positioned so that its hammers 32 will protrude through the opening 21 up into the feed compartment 7 when rotating. A wall 35 combines with the housing 6 to form a narrowing hopper 36 for guiding shredded paper produced by the mill down to the auger assembly 40.

The auger assembly 40 comprises a screw auger 41 working within a transfer tube 42. It is mounted to the compartment side walls 11 and is below and aligned with the hammer mill 30. The transfer tube 42 is semi-circular along its length within the lower chamber 8 and then changes to a fully tubular form as it extends through the side wall 11. As shown, the auger assembly 40 protrudes out of the housing 6. The auger at this end is longer than the tube 42 so that the flights 43 will release the paper being transferred and act like a screw to compress paper in the storage chamber 47. The auger 41 is driven by the pulley and belt assembly 34. The auger 41 is coupled to the assembly 34 by a planetary gear (not shown) so that it can apply increasing torque at constant rotational speed, to maintain its feed rate while compressing the shredded paper 44.

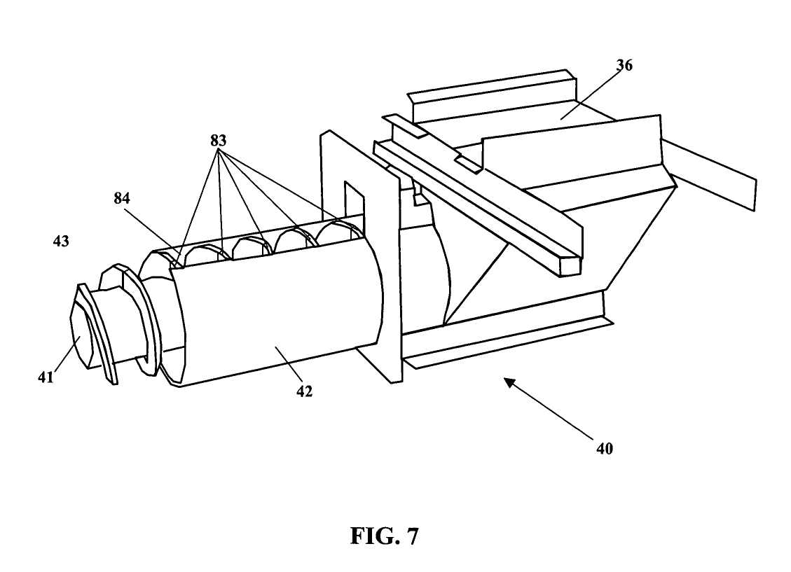

Alternatively, as shown in FIG. 7, the transfer tube 42 may have a relief slot 84 in the top to allow paper to be removed from the auger 41 in the event of a jam in the transfer tube 42. The relief slot 84 has the added advantage of allowing shredded material to spill out of the transfer tube 42 over a broader area during normal operation. 34. If the transfer tube has a relief slot 84, the flights 43 may be confined entirely within the transfer tube 42.

The auger assembly 40 may also be driven by a direct drive from the vehicle transmission. In this embodiment, the vehicle engine is connected to the transmission, from which a shaft 34 extends to a gear on the rear axle. The gear will have a high speed, low speed and neutral position. A pulley hub on the shaft is connected by a pulley to the auger through an auger gear that also has a neutral position. To drive the auger, the rear gear on the vehicle is place in neutral and the auger gear engaged. In this manner, the auger may be driven by the vehicle transmission.

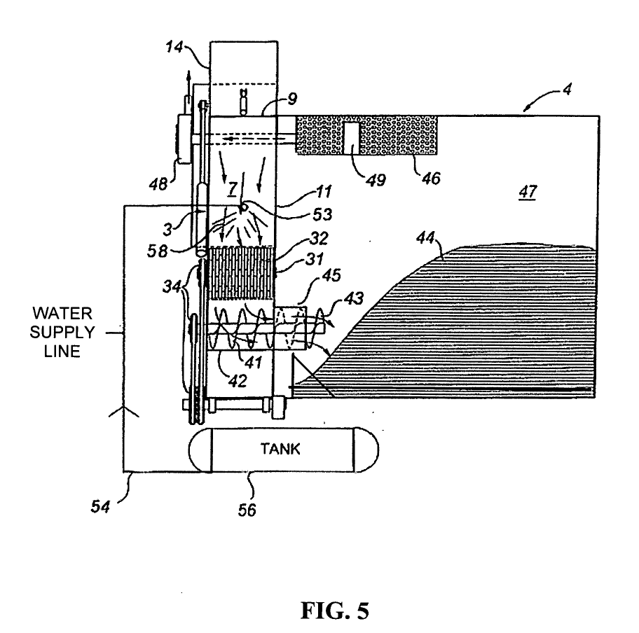

As shown in FIG. 5, the storage container 4 has an inlet 45 through which the auger assembly 40 extends. A filter 46 is mounted to the container 4 within the upper reaches of the storage chamber 47 and is connected with an external blower 48. The blower 48 exerts suction to pull air through the shredder 3 and storage chamber 47 to remove dust. The dust accumulates in the filter 46 and can be dislodged at the end of the shredding run by an air hammer 49, so that it drops into the loaded storage chamber 47.

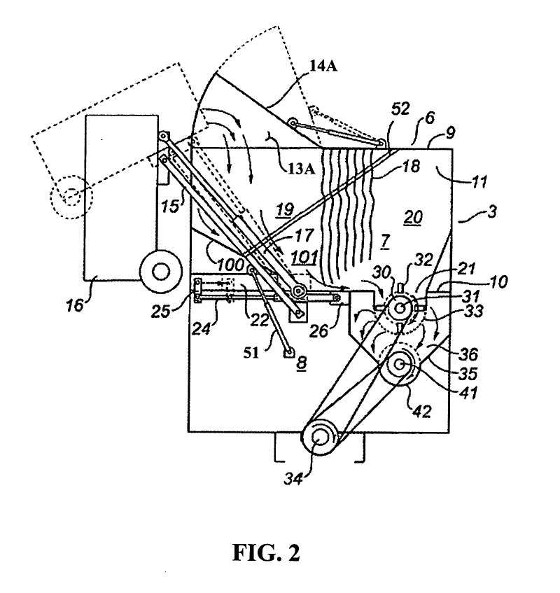

In operation, a loaded receptacle 16 from the office is wheeled to the mobile shredder assembly 1. In the embodiment shown in FIG. 2. the arms 15, biased by the cylinder 51, are actuated to lift and tip the receptacle so that its contents are dumped into the feed compartment front section 19. The paper slides down the baffle 100 to the front of the plunger 22. The plunger biases it to the hammer mill opening 21. The hammers 32 engage and drive the paper into the impact fingers (not shown) to shred the paper. The belting 18 isolates paper thrown up by the hammers and keeps it in the compartment back section 20. Shredded paper exits the hammer mill screen 33 and drops through the hopper 36 into the open auger 41. The flights 43 of the auger advance the shredded paper into the storage chamber 47. The last few flights 43, located beyond the end of the transfer tube 42, function to compress the shredded paper as it fills the chamber 47. The blower 48 functions to draw produced dust through the shredder 3 and storage container 4 into the filter 46, wherein the dust collects. The air hammer 49 can be actuated at the completion of shredding, to dislodge the dust so that it drops into the loaded storage removal for removal.

In a preferred embodiment, as shown in FIG. 8, the receptacle (16 in FIG. 2, but not shown in FIG. 8) will be attached to receptacle holder 87A for shredding or 87B if shredding is not required. The receptacle holder 87A or 87B moves in an upwardly fashion on the guides 86A or 86B to the top of the guides 86A or 86B where the guides 86A or 86B abut the opening 13A or 13B. The cylinder 88A or 88B moves the guides 86A or 86B outward to cause the receptacle (not shown) to tip and empty its contents into the opening 13A or 13B. Shredding of materials is as previously described. Receptacle lift 5A, comprising the guides 86A, receptacle holder 87A, and cylinder 88A, which is associated with the shredder 3 operates independently of receptacle lift 5B, comprising the guides 86B, receptacle holder 87B, and cylinder 88B, which is associated with the storage container 4. Receptacle lifts 5A and 5B may also be operated at the same time.

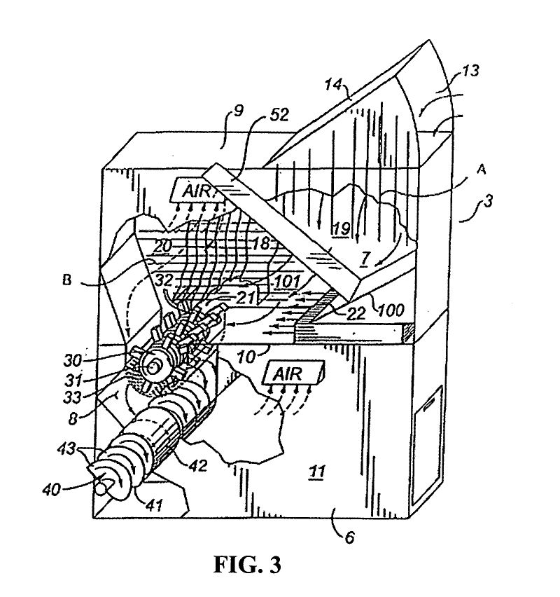

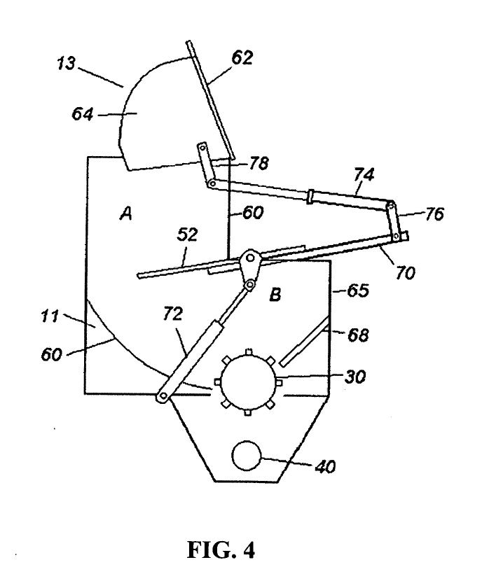

Referring now to FIGS. 2 and 3, a sliding gate 52 divides the feed compartment 7 into a temporary storage space A and a paper shredding space B. The gate 52 is preferably mounted transversely between the feed opening 13 and the hammers 32. The gate 52 may slide on guides (not shown) on either side of the feed compartment 7 or may be supported by a rack (not shown in FIG. 4, but see FIG. 5 discussed below) or other suitable mechanism in the feed compartment 7. The gate 52 may terminate in its travel against the ramp or sloping baffle 100.

An embodiment of the gate 52 is further illustrated in FIG. 4. In this embodiment, the upper part of the walls 11 of the shredder form a hopper 60 having a hinged lid 62. The hinged lid 62 has flanges 64 which surround the opening 13 through which paper may be fed into the shredder. The lower part of the walls 11 surround a paper shredding compartment 65 that contains a hammer mill 30. A ribbed arcuate feed floor 66 guides paper from the hopper 60 towards the hammer mill 30. A further ribbed feed floor 68 extends at the rear of the shredding compartment 65. The hammers 32 pass through between ribs of the ribbed floors 66, 68 in conventional fashion. Shredded paper falls through to an auger 40 below the hammer mill 30. Gate 52 slides on a rack 70 that is secured to the compartment 65. A hydraulic cylinder 72 may be used to open and close the gate 52. A further hydraulic cylinder 74 for opening the lid 62 is mounted on an arm 76 extending from the rack 70 and attached to the lid 62 through a pivoting link 78. Both hydraulic cylinders 72, 74 may be powered by the truck hydraulics.

In both FIGS. 3 and 4, gate 52 divides the shredder into paper storage compartment A and shredding compartment B. The gate 52 may be closed to allow paper to be placed in A while paper in B is being shredded. Once paper in B is shredded, the gate 52 may be opened while the feed compartment opening remains closed to release paper from A into B. This arrangement provides an air lock effect that reduces discharge of paper fragments and dust into the air and regulates the supply of paper into the paper shredding compartment 65.

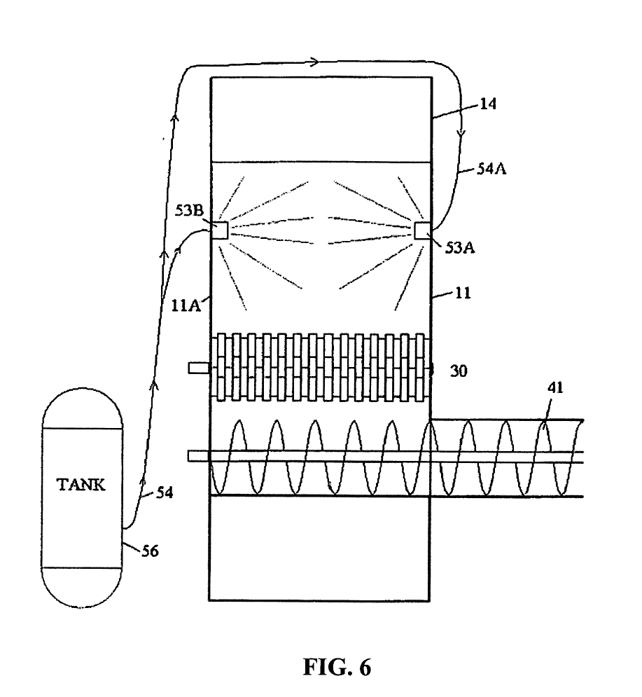

Referring now to FIGS. 5 and 6, a water sprayer 53 is disposed in the feed compartment 7, and is connected through a line 54 to a supply tank 56. The supply tank 56 is preferably a pressurized supply of water, that may be pressurized using compressed air from the truck 2. The sprayer 53 may be any suitable arrangement of nozzles that discharges water as shown in 58 into the feed compartment 7 at any convenient location that allows the water spray to envelope the hammers 32 and cause dust to settle. As shown in FIG.7, the sprayer 53 may be formed by a pair of nozzles 53A, 53B fed respectively by lines 54 and 54A, and which are mounted on opposed side walls 11 and 11A of the paper shredder. A continuous supply of water should be chosen that is sufficient to remove dust particles from the air, but not saturate the paper. An exemplary water feed rate is 1 gal/minute for a paper feed rate of 6000 lbs/hr. A typical water feed rate range is 0-5 gal/min. The nozzles 53A, 53B may be mounted about 12 inches above the hammer mill 30. Nozzles such as are used for spraying crops may be used. The moist environment generated by the water sprayer 53 keeps dust down and reduces the risk of an explosion. Other fire suppression fluids may be substituted for the water, but it is preferred to use water due to its low cost and easy availability.

To further reduce the risk of an explosion hazard, the auger 41 may be equipped with wear plates 83 on the flights 43, as shown in FIG. 7. The wear plates 83 also help to stabilize the auger 41 in operation and to reduce wear. In a preferred embodiment, the flights 43 have a tolerance ranging from ⅜″ to ¾″ between the auger 41 and the transfer tube 42. Attached to the flights 43 are wear plates 83 that stick out approximately ⅜″. The wear plates 83 may be made of any suitable spark resistant material, but in a preferred embodiment, the wear plates 83 are made out of aluminum. When the wear plates 83 have been worn down, they can be easily replaced. This is more economical than replacing the auger 41, and also increases the safety of the system by reducing the likelihood of causing sparks that may ignite the shredded material and dust produced by the hammer mill 30.

The mobile paper shredder 1 with dual receptacle lifts has the advantage of reducing the time required to pick up materials from a location. Previously, materials would have to be shredded, even when this was not required by the customer. With dual receptacle lifts, it is possible to process materials more quickly because the shredder can be bypassed by loading such materials directly into the storage container 4 via receptacle lift 5B.

The mobile shredder 1 can also be provided with storage for receptacles in compartments 90 in front of the shredder 3. The rear 92 of the storage container 4 may be provided with doors that swing outwardly, or with a clamshell that opens in an upward fashion, or with any other suitable means of accessing the storage container 4. The storage container 4 may also be provided with an ejector wall 94 to push the paper out of the storage container. The ejector wall may have a ramp 94 at its base. The floor of the storage container 4 may be flat, but could also have ribs 96. If desired, the storage container 4 may also be separated into separate compartments, one for shredded paper and one for unshredded paper, with separate removal doors for each compartment and corresponding mechanisms for forcing paper towards and through the removal doors.

In the claims, the term “paper shredding implements” includes the described preferred hammers 32 and associated components, but any suitable paper shredding implements may be used. The term “shredded paper disposal container” includes the container 4 but may include any suitable container, fixed or removable.

Immaterial modifications may be made to the embodiments of the invention described here without departing from the invention.

1. A mobile paper shredder, comprising:
a first feed compartment;
a first receptacle lift associated with the first feed compartment for conveying paper to the first feed compartment;
paper shredding implements disposed to receive paper from the first feed compartment and discharge shredded paper;
a conveyor disposed to receive shredded paper discharged by the paper shredding implements and to convey shredded materials to a storage container disposed to receive shredded paper from the conveyor;
a second feed compartment on the storage container;
and a second receptacle lift associated with the second feed compartment for conveying paper into the second feed compartment, the storage container disposed to receive paper from the second feed compartment to store the paper for hauling away.

2. The mobile paper shredder of claim 1 in which the first and second receptacle lifts comprise first and second guides, and first and second receptacle holders attached to the first and second guides.

3. The mobile paper shredder of claim 2 in which the first and second receptacle lifts further comprise first and second hydraulic cylinders attached to the first and second guides, the first hydraulic cylinder capable of movement independently of the second hydraulic cylinder.

4. The mobile paper shredder of claim 1 further comprising at least one storage compartment for storing at least one receptacle.

5. The mobile paper shredder of claim 1 in which the paper conveyed into the second feed compartment by the second receptacle lift is unshredded.
